(19) United States
(12) Patent Application Publication
(10) Pub. No.: US 2012/0112925 A1
(43) Pub. Date: May 10, 2012

(54) APPARATUS AND METHOD FOR MONITORING STATUS OF SATELLITE TRANSPONDER USING STATISTICAL ANALYSIS OF TELEMETRY DATA

(75) Inventors: Moon Hee YOU, Daejeon (KR); Jin Ho Jo, Daejeon (KR); Won-Chan Jung, Daejeon (KR); Jae Hoon Kim, Daejeon (KR)

(73) Assignee: Electronics and Telecomunications Research Institute, Daekepm (KR)

(21) Appl. No.: 13/289,455

(22) Filed: Nov. 4, 2011

(30) Foreign Application Priority Data
Nov. 8, 2010 (KR) 10-2010-0110145

(51) Int. Cl. H04B 17/02

(52) U.S. Cl. 340/870.05

(57) ABSTRACT

Provided are an apparatus and a method for monitoring a status of a satellite transponder using a statistical analysis of telemetry data, which may disclose a configuration to receive at least one of an input signal level and an output signal level with respect to a satellite transponder, to receive telemetry data with respect to the satellite transponder, and to statistically analyze the telemetry data based on the at least one of the input signal level and the output signal level.

### CROSS-REFERENCE TO RELATED APPLICATION

This application claims the priority benefit of Korean Patent Application No. 10-2010-0110145, filed on Nov. 8, 2010, in the Korean Intellectual Property Office, the disclosure of which is incorporated herein by reference.

### BACKGROUND

1. Field

Example embodiments relate to an apparatus and a method for monitoring a status of a satellite transponder by performing a statistical analysis of telemetry data based on at least one of an input signal level and an output signal level of the satellite transponder received from an In-Orbit Test (IOT) and Communication System Monitoring (CSM) apparatus.

2. Description of the Related Art

An existing transponder monitoring and control (TMC) apparatus and an In-Orbit Test (IOT) and Communication System Monitoring (CSM) apparatus separately operate and accordingly, telemetry data received from the TMC apparatus is statistically analyzed based on a time section only.

When a predetermined telemetry value is changed according to a change in an input and an output of satellite transponder components, an analysis for each condition is performed so that a proposed value of telemetry analysis may be used as an accurate reference value. Also, interaction between the TMC apparatus and the IOT and CSM apparatus may be performed for the analysis for each condition.

A recent satellite transponder monitoring scheme is enabled to check whether a satellite transponder is operating normally by examining a status in real time with respect to each component of the satellite transponder using telemetry periodically received from a satellite.

When telemetry information stored in a database is statistically analyzed based on a predetermined period or a tendency of a data value is analyzed to determine whether a satellite transponder normally operates, a real time examination and a real time analysis may not be simultaneously performed and a considerable amount of time may be used to check a status of the satellite transponder.

A range of applications of a telemetry value in a normal status corresponds to a range that is applied from initial launch of a satellite until end-of-life of the satellite. The telemetry value may be helpful to determine whether a status of components of the satellite transponder is normal or abnormal. However, due to a wide range of the telemetry value, using the telemetry value as a standard of judgment to monitor a performance decline or a change in a performance during an operation period of the satellite transponder may be difficult.

### SUMMARY

The example embodiments may include a satellite transponder monitoring apparatus including an input/output signal level receiver to receive at least one of an input signal level and an output signal level with respect to a satellite transponder, a telemetry data receiver to receive telemetry data with respect to the satellite transponder, and a telemetry data analyzer to statistically analyze the telemetry data based on the at least one of the input signal level and the output signal level.

The example embodiment may also include a satellite transponder monitoring method including receiving at least one of an input signal level and an output signal level with respect to a satellite transponder and telemetry data with respect to the satellite transponder, storing the received at least one of the input signal level and the output signal level and the received telemetry data, and statistically analyzing the stored telemetry data based on the stored at least one of the input signal level and the output signal level.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a diagram to describe a monitoring system including a satellite transponder monitoring apparatus according to example embodiments;

FIG. 2 illustrates a block diagram to describe an In-Orbit Test (IOT)/Communication System Monitoring (CSM) apparatus that may interact with a satellite transponder monitoring apparatus according to example embodiments;

FIG. 3 illustrates a block diagram to describe a satellite transponder monitoring apparatus according to example embodiments;

FIG. 4 illustrates a diagram to describe telemetry data that may be stored in a satellite transponder monitoring apparatus according to example embodiments; and FIG. 5 illustrates a diagram to describe a monitoring method where a satellite transponder monitoring apparatus is applied according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

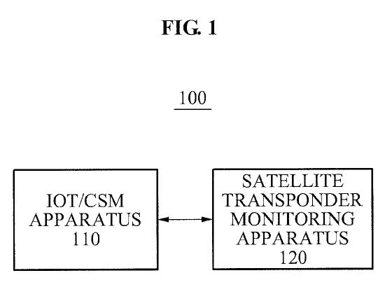

FIG. 1 illustrates a diagram to describe a monitoring system 100 including a satellite transponder monitoring apparatus 120 according to example embodiments.

The monitoring system 100 may examine a performance of a satellite transponder or monitor a system of a satellite relay network.

The monitoring system 100 may include an In-Orbit Test (IOT)/Communication System Monitoring (CSM) apparatus 110 and the satellite transponder monitoring apparatus 120.

The IOT/CSM apparatus 110 may be used for examining a performance of a satellite transponder, and may assume a satellite transponder signal level based on a signal received from the satellite transponder by responding to a continuous wave (CW) generated in a signal generator.

The satellite transponder monitoring apparatus 120 may receive the assumed satellite transponder signal level and store the assumed satellite transponder signal level, and may store telemetry data that may be input in real time by concatenating the telemetry data with a value corresponding to the satellite transponder signal level.

The satellite transponder monitoring apparatus 120 may statistically analyze the telemetry data based on the stored satellite transponder signal level.

The satellite transponder monitoring apparatus 120 may use an input signal level and an output signal level of a satellite transponder of the IOT/CSM apparatus 110 as a condition of classifying a telemetry value with respect to a component performance when analyzing a statistical characteristic of analog telemetry data in a predetermined period.

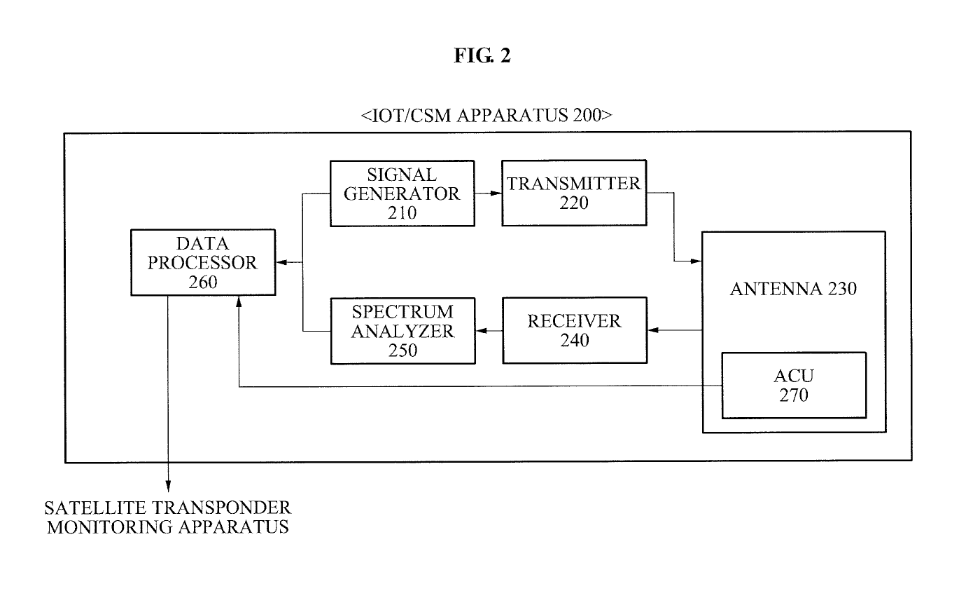

FIG. 2 illustrates a block diagram to describe an IOT/CSM apparatus 200 that may interact with a satellite transponder monitoring apparatus according to example embodiments.

The IOT/CSM apparatus 200 may generate an appropriate CW signal in a signal generator 210 to examine a performance of a satellite transponder.

The IOT/CSM apparatus 200 may transmit the generated CW signal to a transmitter 220, and to the satellite transponder via an antenna 230.

The IOT/CSM apparatus 200 may receive, at a receiver 240 via the antenna 230, a response signal with respect to the transmitted CW signal. The IOT/CSM apparatus 200 may read the received response signal using a spectrum analyzer 250.

Also, the IOT/CSM apparatus 200 may receive all signals that may use the satellite transponder, and read the received signals using the spectrum analyzer 250, to monitor a system of a satellite relay network.

A data processor 260 may determine at least one of an input signal level and an output signal level of the satellite transponder by analyzing a revised output of a signal generator 210, an input signal of the spectrum analyzer 250, and a beacon signal level read by an ACU 270 of the antenna 230.

The IOT/CSM apparatus 200 may store data associated with the assumed at least one of the input signal level and the output signal level, and output the stored data on a screen for confirming identity of an administrator.

According to example embodiments, the satellite transponder monitoring apparatus may statistically analyze telemetry data using the at least one of an input signal level and an output signal level of the satellite transponder assumed by the IOT/CSM apparatus 200.

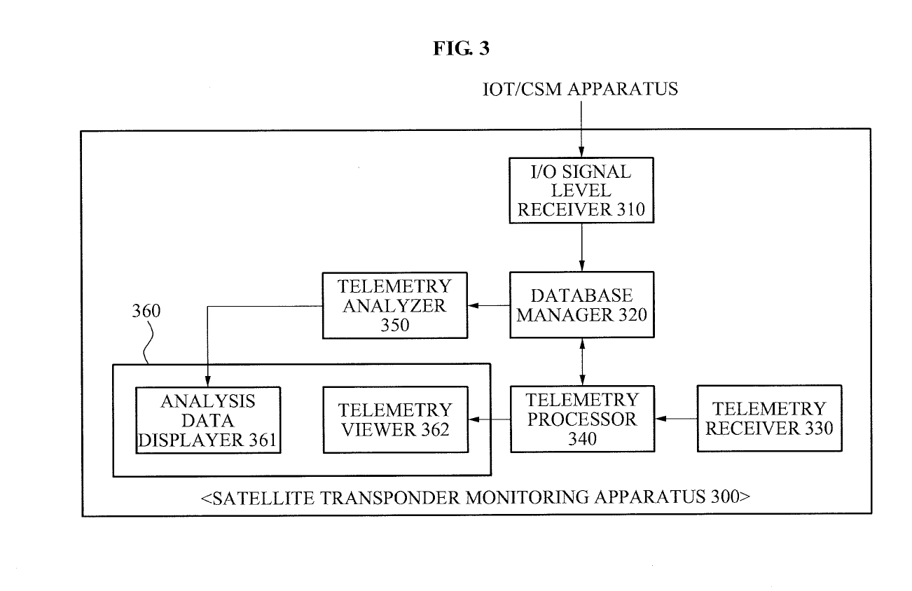

FIG. 3 illustrates a block diagram to describe a satellite transponder monitoring apparatus 300 according to example embodiments.

The satellite transponder monitoring apparatus 300 may include an input/output signal level receiver 310, a database manager 320, a telemetry receiver 330, a telemetry processor 340, and a telemetry analyzer 350.

The input/output signal level receiver 310 may receive at least one of an input signal level and an output signal level with respect to a satellite transponder.

As described in FIG. 2, the input/output signal level receiver 310 may receive the at least one of the input signal level and the output signal level determined by an IOT/CSM apparatus.

The database manager 320 may store the received at least one of the input signal level and the output signal level in a database and manage the stored at least one of the input signal level and the output signal level. The telemetry receiver 330 may receive telemetry data with respect to the satellite transponder and parse the received telemetry data, and then may control to store the telemetry data in the database using the database manager 320.

The database manager 320 may concatenate a value corresponding to the received at least one of the input signal level and the output signal level and the telemetry data, and may store and mange the at least one of the input signal level and the output signal level and the telemetry data. That is, the database manager 320 may simultaneously process telemetry data of the satellite transponder that may be input in real time, and satellite transponder input signal levels and satellite transponder output signal levels that may be analyzed in the data processor of the IOT/CSM apparatus, and store, in the database, the telemetry data and the satellite transponder input signal levels and the satellite transponder output signal levels.

The satellite transponder monitoring apparatus 300 may further include a displayer 360 to display a result of the analysis.

The displayer 360 may include an analysis data displayer 361 to display analyzed telemetry data, and a telemetry viewer 362 to display telemetry data before analyzing.

The telemetry processor 340 may display, on the telemetry viewer 362, the telemetry data received in the telemetry receiver 330 to display the telemetry data before analyzing. Here, the telemetry viewer 362 may process the received telemetry data as a quantitative indication, such as a graph, a number, and the like, and display the processed telemetry data. Similarly, the analysis data displayer 361 may display the analyzed telemetry data using the telemetry analyzer 350.

The telemetry analyzer 350 may load analog telemetry data among past telemetry data stored in the database, and perform a statistical analysis such as a minimum value, a maximum value, an average value, an extent of distribution, and the like.

The telemetry analyzer 350 may statistically analyze, for each period, the telemetry data with respect to the component performance of the satellite transponder using the at least one of the input signal level and the output signal level.

The telemetry analyzer 350 may classify a value of telemetry data with respect to the component performance of the satellite transponder based on at least one of an input signal level and an output signal level of a satellite transponder of the IOT/CSM apparatus when analyzing a statistical characteristic of analog telemetry data during a predetermined period.

For example, main current telemetry data corresponding to a type of telemetry data of a traveling-wave tube amplifier (TWTA) corresponding to one of high power amplifiers, may have a different size based on an input signal level of the TWTA.

Accordingly, when analyzing a distribution with respect to a value of main current telemetry data without any classification, a problem may occur in having a considerably great extent of distribution.

When an input of an A level signal and an input of B level signal are identically processed, it may be difficult to assess an extent of degradation of the TWTA or an extent of aging of the TWTA due to a change in a value of main current telemetry. However, when an analysis is performed for a predetermined section based on an input signal level and an output signal level of the satellite transponder, more accurate assessment of the extent of degradation of the TWTA or the extent of aging of the TWTA may be possible due to the change in a value of main current telemetry.

When a statistical analysis of telemetry data is performed using the satellite transponder monitoring apparatus 300, a status of the satellite transponder may be promptly and accurately monitored, and a determination on normality of analog telemetry data of the satellite transponder may be more precisely performed.

The satellite transponder monitoring apparatus 300 may monitor a performance decline or a change in a performance during an operation period of the satellite transponder, and may simultaneously compare an analysis value with respect to a status of telemetry data, thereby promptly determining whether the telemetry is normal.

The analysis data displayer 361 may display a result of the statistical analysis.

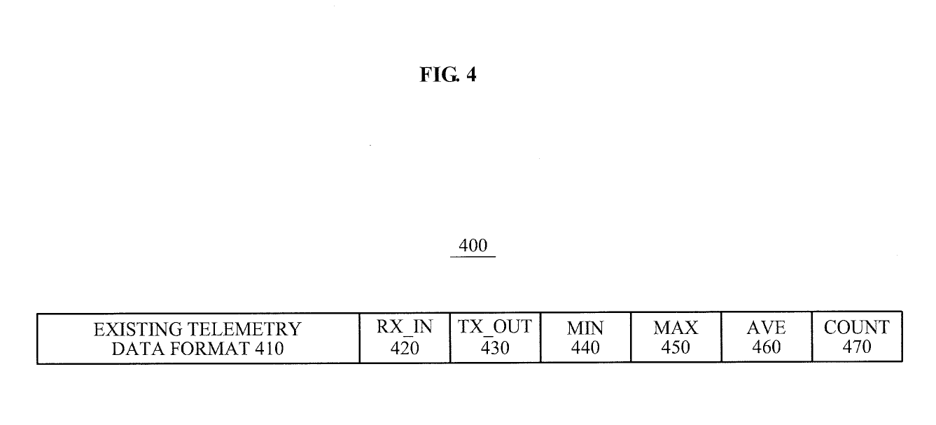

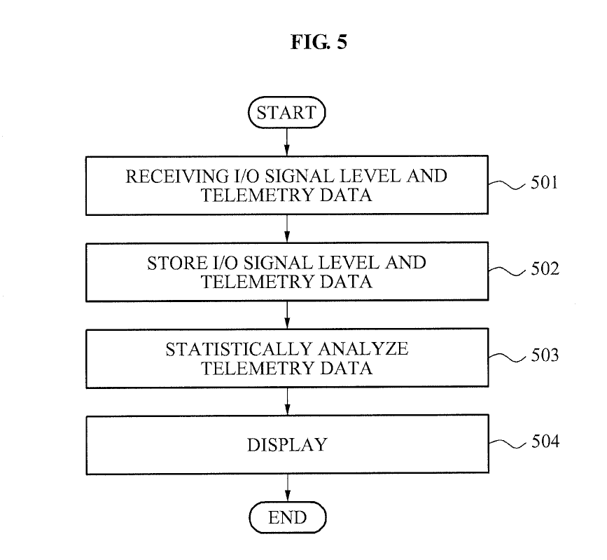

FIG. 4 illustrates a diagram to describe telemetry data that may be stored in a satellite transponder monitoring apparatus according to example embodiments.

FIG. 4 illustrates a diagram of a format 400 of telemetry data that may be processed in a database manager of the satellite transponder monitoring apparatus, and may be stored in a database.

The format 400 of the telemetry data to be stored in the database may include data of an Rx_IN 420, a Tx_OUT 430, a MIN 440, a MAX 450, an AVE 460, and a COUNT 470 in addition to an existing telemetry data format 410.

The Rx_IN 420 may correspond to an input signal level of the satellite transponder monitoring apparatus, and the Tx_OUT 430 may correspond to an output signal level of the satellite transponder. The input signal level and the output signal level may be confirmed using the Rx_IN 420 and the Tx-OUT 430.

The MIN 440 may correspond to a minimum value among telemetry data stored to date, and the MAX 450 may correspond to a maximum value among the telemetry data stored to date.

The AVE 460 may correspond to an average value of the telemetry data up to the present point in time, and the COUNT 470 may correspond to a number of times of receiving the telemetry data up to the present point in time.

The Rx_IN 420 and the Tx-OUT 430 may be received from the IOT/CSM apparatus.

The MIN 440 and the MAX 450 may be calculated by comparing with a preceding value after receiving the telemetry data.

The AVE 460 may be calculated by multiplying the AVE 460 by ((COUNT−1)/COUNT) and then adding (TM_VALUE/COUNT).

A real time telemetry viewer and an analysis data displayer with respect to preceding data separately operated in the past. However, according to example embodiments, an assessment with respect to a current telemetry value may be performed in real time by comparing, on the telemetry viewer, current telemetry data and a statistical value of telemetry data accumulated to date.

FIG. 5 illustrates a diagram to describe a monitoring method where a satellite transponder monitoring apparatus is applied according to example embodiments.

In operation 501, the satellite transponder monitoring method may receive at least one of an input signal level and an output signal level with respect to a satellite transponder, and telemetry data with respect to the satellite transponder.

The at least one of the input signal level and the output signal level with respect to the satellite transponder may be received from an IOT/CSM apparatus, and the telemetry data may be received in real time from the satellite transponder.

In operation 502, the satellite transponder monitoring method may store the received at least one of the input signal level and the output signal level and the telemetry data by concatenating a value corresponding to the received at least one of the input signal level and the output signal level and the telemetry data.

Here, at least one of a maximum value of accumulated telemetry data, a minimum value of the telemetry data, an average value of the telemetry data, and a number of times of receiving the telemetry data may be stored in the database.

In operation 503, the satellite transponder monitoring method may statistically analyze the stored telemetry data based on the stored at least one of the input signal level and the output signal level.

For example, the satellite transponder monitoring method may statistically analyze, for each period, the telemetry data with respect to a component performance of the satellite transponder using the at least one of the input signal level and the output signal level.

In operation 504, the satellite transponder monitoring method may display a result of the statistical analysis using a display apparatus.

The satellite transponder monitoring method may monitor an abnormality of current telemetry data by comparing telemetry data that may be received in real time, and an average value of accumulated telemetry data to date.

The satellite transponder monitoring method may promptly and accurately monitor a status of a satellite transponder by monitoring the abnormality of the current telemetry data.

The satellite transponder monitoring method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

According to example embodiments, a performance decline or a change in a performance during an operation period of a satellite transponder may be monitored.

According to example embodiments, a status of a satellite transponder may be promptly and accurately monitored by statistically analyzing telemetry data received from a satellite in real time, based on at least one of an input signal level and an output signal level of the satellite transponder.

According to example embodiments, a determination on normality of analog telemetry data of the satellite transponder may be more precisely performed by analyzing telemetry data based on at least one of an input signal level and an output signal level of the satellite transponder.

According to example embodiments, normality of telemetry may be promptly determined by simultaneously comparing an analysis value with respect to a status of telemetry data in real time.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite transponder monitoring apparatus, comprising:
an input/output signal level receiver to receive at least one of an input signal level and an output signal level of a satellite transponder;
a telemetry data receiver to receive telemetry data of the satellite transponder; and
a telemetry data analyzer to statistically analyze the received telemetry data based on the received at least one of the input signal level and the output signal level.

2. The apparatus of claim 1, wherein the telemetry data analyzer statistically analyzes, for each period, the telemetry data with respect to a component performance of the satellite transponder using the received at least one of the input signal level and the output signal level.

3. The apparatus of claim 1, further comprising:
a database manager to store the received at least one of the input signal level and the output signal level and the telemetry data by concatenating a value corresponding to the received at least one of the input signal level and the output signal level with the telemetry data.

4. The apparatus of claim 3, wherein the database manager stores at least one of a maximum value of telemetry data stored in advance, a minimum value of the telemetry data stored in advance, an average value of the telemetry data stored in advance, and a number of times of receiving the telemetry data stored in advance.

5. The apparatus of claim 1, wherein the telemetry data analyzer compares and statistically analyzes telemetry data stored in advance and the received telemetry data.

6. The apparatus of claim 1, further comprising:
a displayer to display the received telemetry data and a result of the statistical analysis of the received telemetry data.

7. A satellite transponder monitoring method, comprising:
receiving at least one of an input signal level and an output signal level of a satellite transponder and telemetry data of the satellite transponder;
storing the received at least one of the input signal level and the output signal level and the received telemetry data; and
statistically analyzing the stored telemetry data based on the stored at least one of the input signal level and the output signal level.

8. The method of claim 7, wherein the statistically analyzing of the stored telemetry data comprises:
statistically analyzing, for each period, the telemetry data with respect to a component performance of the satellite transponder using the stored at least one of the input signal level and the output signal level.

9. The method of claim 7, further comprising:
storing at least one of a maximum value of telemetry data stored in advance, a minimum value of the telemetry data stored in advance, an average value of the telemetry data stored in advance, and a number of times of receiving the telemetry data stored in advance.

10. The method of claim 7, further comprising:
comparing and statistically analyzing telemetry data stored in advance and the received telemetry data.

11. The method of claim 7, further comprising:
displaying the received telemetry data and a result of the statistical analysis of the stored telemetry data.
